(19) United States
(12) Patent Application Publication
(10) Pub. No.: US 2007/0101047 A1
(43) Pub. Date: May 3, 2007

(54) Memory apparatus and controller

(76) Inventors: Kiyoshi Kamiya, Kodaira (JP); Takayuki Tamura, Fuchu (JP); Fumio Hara, Higashikurume (JP); Kunihiro Katayama, Chigasaki (JP)

Correspondence Address: MILES & STOCKBRIDGE PC, 1751 PINNACLE DRIVE, SUITE 500, MCLEAN, VA, 22102-3833, US

(21) Appl. No.: 10/561,795

(22) PCT Filed: Dec. 22, 2004
(86) PCT No.: PCT/JP04/19183

§ 371 Date: Dec. 21, 2005

(51) Int. Cl. G06F 12/00; G06F 13/00

(52) U.S. Cl. 711/103; 711/159; 711/202

(57) ABSTRACT

A memory apparatus having a rewritable nonvolatile memory, and a control circuit. The memory apparatus brings logical addresses into correspondence with physical addresses of the nonvolatile memory and retains a piece of number-of-rewrites information for each logical address. The control circuit can perform a replacement process of a piece of memory information on the nonvolatile memory. In the replacement process, a given logical address judged to have a small number of rewrites based on the number-of-rewrites information is replaced so as to correspond to a different physical address and then data is transferred according to the replacement. Even when data of the logical address smaller in the number of rewrites is assigned to the different physical address, the number of rewrites of the region is still grasped as the number of rewrites of the logical address. The data of the logical address is maintained in a condition such that it can be easily targeted for the rewrite by the replacement process even in the place to which the data is transferred. Thus, a memory cell is made less prone to accumulatively suffering disturb owing to rewrite.

### FIELD OF THE INVENTION

The present invention relates to a nonvolatile memory apparatus, e.g. a flash memory card and a flash disk compatible with a hard disk, and a controller that is applied to the memory apparatus.

### BACKGROUND OF THE INVENTION

When an electrically rewritable nonvolatile memory typified by a flash memory is rewritten, a memory cell thereof suffers an electrical stress, and thus the characteristics of the memory cell is deteriorated with an increase in the number of rewrites. Locally concentrated writing causes only some data blocks to be remarkably deteriorated in their characteristics. On this account, in flash memory cards, such local concentration of deterioration of characteristics on a local address can be relaxed by appropriately changing correspondences of logical addresses and physical addresses. In this case, a correspondence table in which correspondence of a physical address of a memory region and a logical address from a host is defined as exemplarily shown in JP-A-8-16482 may be used.

In regard to an electrically rewritable nonvolatile memory typified by a flash memory, when a memory cell transistor that is not targeted for rewrite shares a word line or a bit line with a memory cell transistor targeted for rewrite, the memory cells are influenced by so-called word line disturb or bit line disturb. As a result, their threshold voltage is changed accumulatively and therefore the memory information can be undesirably inverted (make transformed information).

As for a technique to cope with such data transformation, JP-A-2004-310650 discloses as follows: in a flash memory card, a memory region where rewrite is no made can be prevented from suffering disturb accumulatively by writing stored data in a first memory region having a relatively smaller number of rewrites into an unused second memory region and making the second memory region subjected to the writing a used region instead of the first memory region. The judgment on the number of rewrites therein is made focusing on the number of rewrites for each physical address of the memory region. A similar technique is described in U.S. Pat. No. 5,568,439.

### SUMMARY OF THE INVENTION

The inventor examined a technique to relax the influence of accumulation of disturb by relocating stored data in a memory region having a relatively smaller number of rewrites into a free memory region or the like. As a result of the examination, the inventor found out that when numbers of rewrites grasped by the physical address are used as guideposts as in the cases of JP-A-2004-310650 and U.S. Pat. No. 5,568,439, there is the following disadvantage.

That is, in the case where numbers of rewrites of the physical addresses are used as guideposts, a logical address having a small number of rewrites is assigned to a physical address having a large number of rewrites, the physical address becomes difficult to rewrite, and further it is required to wait until a large number of rewrites are performed on the other physical addresses for the before it is judged that the number of rewrites of the physical address in question is relatively smaller. As a result, the physical address in question would be influenced by disturb for a long time. In addition, a physical address having a large number of rewrites has suffered stresses caused by write and erase accumulatively and as such, it is conceivable that its resistance against a stress owing to disturb has lowered. In that case, the influence of disturb is expected to be larger.

Therefore, it is an object of the invention to make a memory cell less prone to being influenced by disturb owing to rewrite accumulatively.

The above and other objects and novel features of the invention will be apparent from the description hereof and the accompanying drawings.

The outlines of the representatives of the subject matters disclosed herein will be described below in brief.

[1] A memory apparatus (1) includes: a rewritable nonvolatile memory (2); and a control circuit (5), wherein the memory apparatus brings logical addresses into correspondence with physical addresses of the nonvolatile memory and retains a piece of number-of-rewrites information for each logical address, wherein the control circuit can perform a replacement process of a piece of memory information on the nonvolatile memory, and wherein the replacement process is a process of replacing a first physical address corresponding to a given logical address judged to have a small number of rewrites based on the pieces of number-of-rewrites information with a second physical address so as to bring the given logical address into another correspondence with the second physical address and performing data transfer according to the replacement.

With the above-described means, numbers of rewrites are managed in the logical address, and therefore it is easy to grasp a logical address that is less prone to being rewritten. Even when data of a logical address having a small number of rewrites is assigned to another physical address, the number of rewrites for the region can be still grasped as the number of rewrites of the logical address. Therefore, the data of the logical address is maintained in a condition such that it is easily targeted for rewrite by the replacement process even in the place to which the data is transferred. Disturb owing to rewrite is a phenomenon accumulated on data for which rewrite is not performed. When a condition such that rewrite by the replacement process is easy to execute is maintained on the data of a logical address for which rewrite according to a direction for writing from a host is rarely caused. Thus, a memory cell can be made less prone to accumulatively suffering disturb owing to rewrite.

In a representative concrete form of the invention, the second physical address is a free physical address used for a correspondence with no logical address. In another representative concrete form of the invention, the second physical address is a physical address corresponding to a second logical address of the logical addresses, having a larger number of rewrites in comparison to the given logical address having the small number of rewrites, and in this case the second logical address is changed so as to be brought into correspondence with the first physical address to which the given logical address having the small number of rewrites was assigned.

By replacing data of a logical address having a large number of rewrites with data of a logical address having a small number of rewrites, the physical address for which the number of rewrites was large (i.e. physical address subjected to many electrical stresses owing to rewrites) can be made less prone to suffering rewrite stresses in turn.

Further, in still another representative concrete form of the invention, the replacement process can be performed concurrently with a process in response to a direction for writing provided from an outside of a memory card. In this case, the replacement process can be performed when the number of rewrites of the logical address targeted for the process in response to the direction for writing reaches a given number of times. Also, the replacement process can be performed on a logical address having a smallest number of rewrites, of arbitrarily extracted logical addresses.

Further, in another representative concrete form of the invention, during the process in response to the direction for writing, the control circuit brings the logical address targeted for the process into correspondence with a third physical address and performs data rewrite. In addition, the nonvolatile memory has an address translation table in which correspondences of the logical addresses and physical addresses are defined. The number-of-rewrites information for each logical address is retained in a region of the physical address corresponding to the logical address. Otherwise, the number-of-rewrites information for each logical address is retained in a number-of-rewrites table.

[2] A memory card has: a rewritable nonvolatile memory; and a control circuit, wherein the memory card brings logical addresses into correspondence with physical addresses of the nonvolatile memory, and retains a piece of number-of-rewrites information for each logical address, the control circuit can executes a rewrite process of the nonvolatile memory in response to a direction for writing from an outside, and a replacement process of memory information on the nonvolatile memory, and the replacement process is a process of replacing a first physical address corresponding to a given logical address judged to have a small number of rewrites based on the pieces of number-of-rewrites information with a second physical address so as to bring the given logical address into another correspondence with the second physical address and performing data transfer according to the replacement. Thus, the data of a logical address that rewrite was rarely caused according to a direction for writing from the host is brought to a condition where rewrite by the replacement process is easy to perform on the logical address, and therefore the memory cell can be made less prone to suffering disturb owing to rewrite accumulatively.

[3] A controller (5) performs host interface control and memory control on a rewritable nonvolatile memory, brings logical addresses into correspondence with physical addresses of the nonvolatile memory to manage a piece of number-of-rewrites information for each logical address. Also, the controller can execute a replacement process in performing rewrite on the nonvolatile memory. In the controller, the replacement process is a process of replacing a first physical address corresponding to a given logical address judged to have a small number of rewrites based on the pieces of number-of-rewrites information with a second physical address so as to bring the given logical address into another correspondence with the second physical address and performing data transfer according to the replacement. Thus, the data of a logical address that rewrite was rarely caused according to a direction for writing from the host is brought to a condition where rewrite by the replacement process is easy to perform on the logical address, and therefore the memory cell can be made less prone to suffering disturb owing to rewrite accumulatively.

In a representative concrete form of the invention, wherein the second physical address is an unoccupied one that is not used for correspondence with a logical address. The second physical address is a physical address corresponding to a second logical address of the logical addresses, having a larger number of rewrites in comparison to the given logical address having the small number of rewrites, and the second logical address is changed so as to be brought into correspondence with the first physical address to which the given logical address having the small number of rewrites was assigned.

In a representative concrete form of the invention, the replacement process can be performed concurrently with a process in response to a direction for writing on a volatile memory provided form an outside thereof. In addition, the replacement process can be performed when the number of rewrites of the logical address targeted for the process in response to the direction for writing reaches a given number of times. Further, the replacement process can be performed on a logical address having a smallest number of rewrites, of arbitrarily extracted logical addresses.

### BRIEF DESCRIPTION OF THE DRAWINGS

FIG. 1 is a block diagram of a flash memory card that is an example of a memory apparatus according to the invention;

FIG. 2 is an illustration exemplarily showing a data configuration of a user region;

FIG. 3 is an illustration exemplarily showing a data configuration of a system region;

FIG. 4 is an illustration exemplarily showing how to update data in a user region during a rewrite process;

FIG. 5 is a flow chart exemplarily showing the flow of data updating process in the rewrite process;

FIG. 6 is an illustration exemplarily showing how to update data in the user region during the replacement process;

FIG. 7 is a flow chart exemplarily showing the flow of the replacement process;

FIG. 8 is an illustration showing another example of the replacement process;

FIG. 9 is an illustration showing another example of the replacement process;

FIG. 10 is an illustration exemplarily showing a number-of-rewrites table; and

FIG. 11 is a block diagram showing an example of the flash memory.

### DETAILED DESCRIPTION OF THE PREFERRED EMBODIMENTS MEMORY CARD

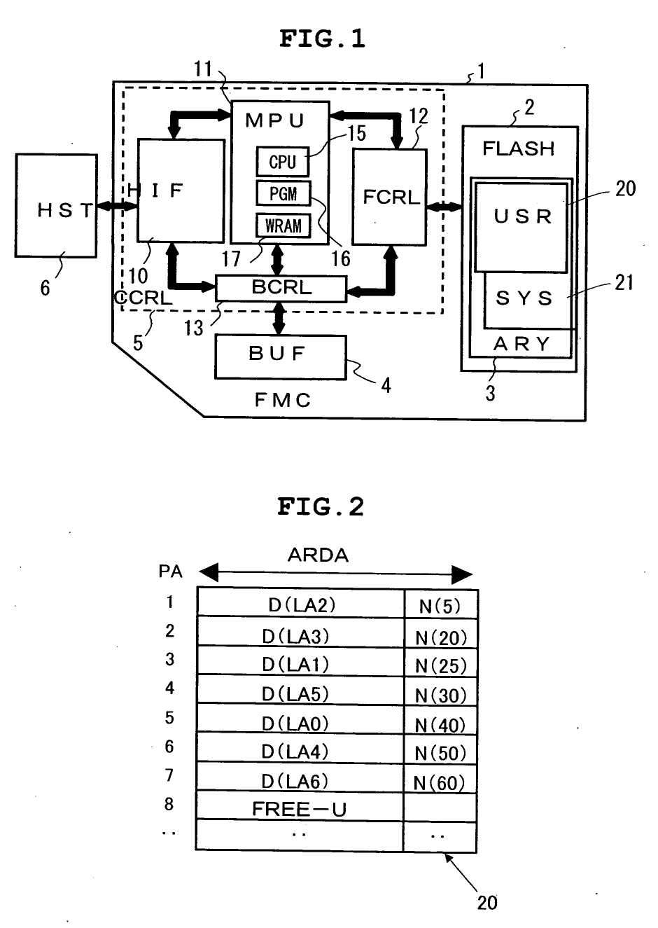

An example of a memory apparatus according to the invention, a flash memory card is shown in FIG. 1. The flash memory card (FMC) 1 has, on its mounting board: an erasable and writable nonvolatile memory, e.g. a flash memory (FLASH) 2; a buffer memory (BUF) 4 including a DRAM (Dynamic Random Access Memory) or an SRAM (Static Random Access Memory); a card controller (CCRL) 5 used as a control circuit that performs memory control and external interface control.

The buffer memory 4 and the flash memory 2 are access-controlled by the card controller 5. The flash memory 2 has a memory array (ARY) 3 in which many electrically erasable and writable nonvolatile memory cell transistors are arrayed in a matrix, but those are not shown in the drawing particularly. The memory cell transistor (also referred to as flash memory cell) includes a source and drain formed in a semiconductor substrate or a well, a floating gate formed in a channel region between the source and drain through a tunnel oxide film, and a control gate overlaid through an interlayer dielectric film on the floating gate, but those are not shown in the drawing particularly. The control gate is connected to a corresponding word line. The drain is connected to a corresponding bit line. The source is connected to a source line. The threshold voltage of the memory cell transistor is raised when electrons are injected into the floating gate, and it is lowered when electrons are withdrawn from the floating gate. Information based on whether the threshold voltage is above or below a word line voltage (a voltage applied to the control gate) to read out data will be kept in the memory cell transistor. Herein, a state where the threshold voltage of the memory cell transistor is below the word line voltage is referred to as an erase state, and a state where the threshold voltage is above the word line voltage is referred to as a write state, which is not a particular restriction. The memory array 3 has a user region (USR) 20 and a system region (SYS) 21.

The card controller 5 in FIG. 1 performs external interface control adhering to IDE disk interface specifications, etc. between the flash memory card and a host computer (HST) 6 used as e.g. a host. The card controller 5 has the access control function of following a direction from the host computer 6 to access the flash memory 2. The access control function is a hard disk-compatible control function. For example, when the host computer 6 manages a set of sector data as file data, the card controller 5 brings a sector address as a logical address into correspondence with a physical memory address to perform access control to the flash memory 2, etc. Referring to FIG. 1, the card controller 5 includes a host interface circuit (HIF) 10, a microprocessor (MPU) 11 used as an arithmetic and control means, a flash controller (FCRL) 12, and a buffer controller (BCRL) 13.

The MPU 11 includes a CPU (Central Processing Unit) 15, a program memory (PGM) 16, and a work RAM (WRAM) 17, and controls the card controller 5 generally. The program memory 16 retains an operation program for the CPU 15, etc.

The host interface circuit 10 is a circuit that follows a given protocol such as ATA (ATAttachment), IDE (Integrated Device Electronics), SCSI (Small Computer System Interface), MMC (Multi Media Card: Registered Trademark), or PCMCIA (Personal Computer Memory Card International Association) to establish interface with the host computer 6 such as a personal computer or a workstation. The control of host interface operation is performed by MPU 11.

The buffer controller 13 follows an access direction provided from MPU 11 to control a memory access operation to the buffer memory 4. In the buffer memory 4, data input to the host interface 10 or data that is to be output from the host interface 10 is held temporarily. In the buffer memory 4, data read out from the flash memory 2 or data that is to be written into the flash memory 2 is held temporarily.

The flash controller 12 follows an access direction provided from the MPU 11 to control readout operation, erase and write operations on the flash memory 2. The flash controller 12 outputs readout control information including a readout command code and readout address information during the readout operation, outputs write control information including a write command code and write address information during the write operation, and outputs erase control information including an erase command during the erase operation.

A data configuration of the user region 20 is shown exemplarily in FIG. 2. In the user region 20, data D(LAn) of a logical address LAn (n=1, 2, . . . ) and data N(m) of a number m of rewrites of the logical address, which are associated with each other for each physical address, are held in a data region ARDAT of a physical address PAi (i=1, 2, . . . ) of the memory array. For example, in the data region ARDAT of the physical address PA1, data D(LA2) of the logical address LA2 and data N(5) of a number of rewrites of 5 are held. Here, the physical address PA8 is for a free region (FREE-U) of the user region (USR) 20. The free region means that no logical address is assigned to the physical address.

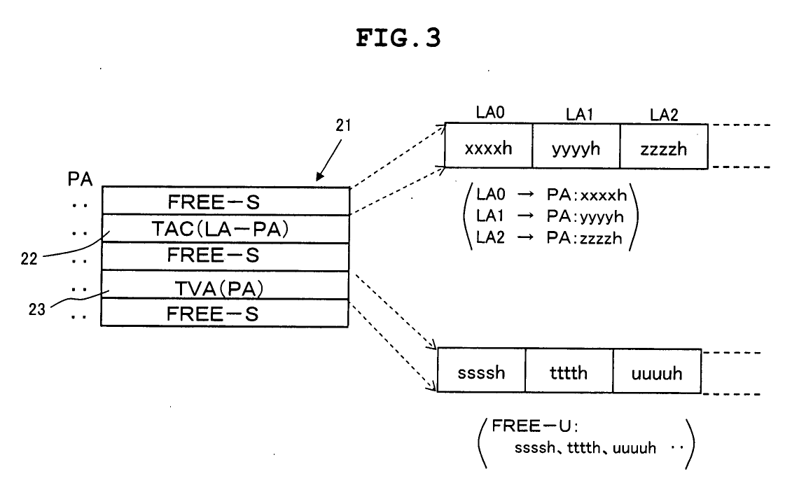

A data configuration of the system region 21 is exemplarily shown in FIG. 3. In the system region 21, the following are held in given physical addresses PAi of the memory array 3: an address translation table (TAC) 22 containing the definition of correspondences between physical and logical addresses; and a free region table (TVA) 23 containing the definition of physical addresses of free data regions FREE-U. The address translation table 22 is a unit definition region that is intended to define a physical address corresponding to a logical address for each storage unit such as up to two bits from the beginning in order from the address LA0. For example, physical address information xxxxh is stored in the unit definition region for the logical address LA0, physical address information yyyyh is stored in the unit definition region for the subsequent logical address LA1, and physical address information zzzzh is stored in the unit definition region for the further subsequent logical address LA2. The free region table 23 is a unit definition region that is intended to define a physical address of a free data region FREE-U for each storage unit such as up to two bits from the beginning. For example, pieces of physical address information ssssh, tttth, uuuuh of free data regions FREE-U from the beginning are stored. FREE-S is a free region in the system region (SYS) 21.

Rewrite Process

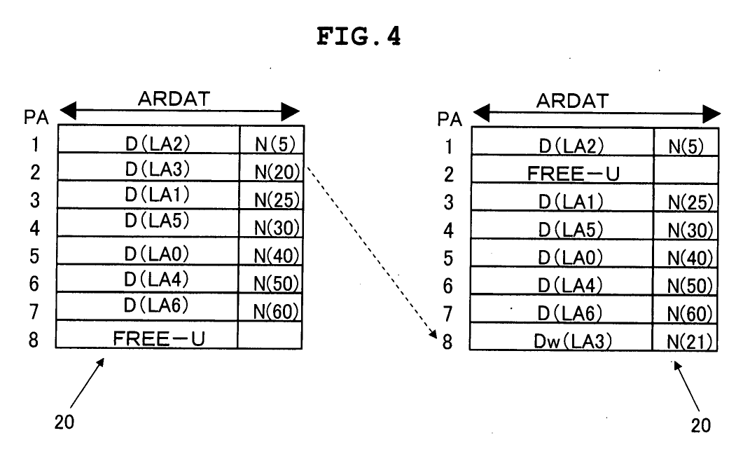

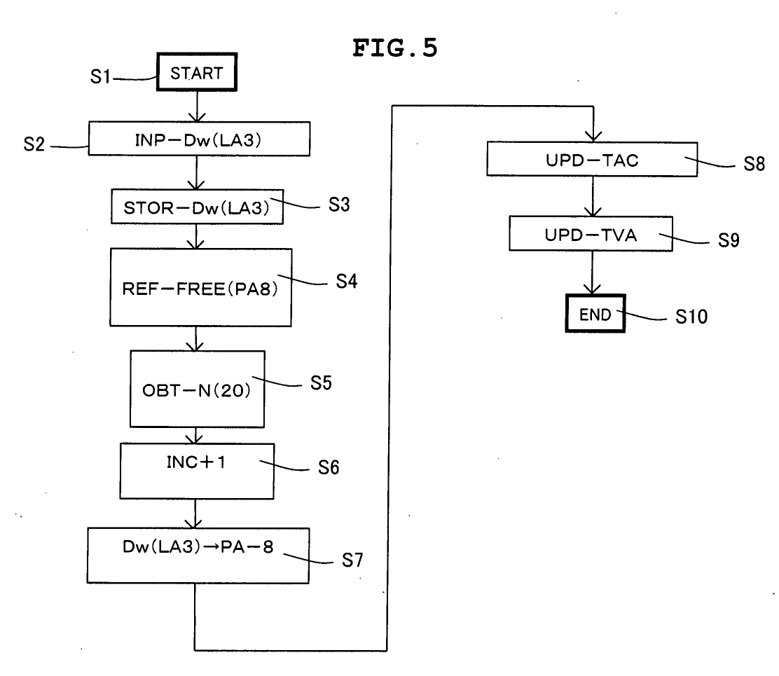

Now, the rewrite process of the flash memory 2 that is executed in response to a direction for writing from the host computer 6 will be described. FIG. 4 exemplarily shows how to update data in the user region during the rewrite process. FIG. 5 exemplarily shows the flow of data updating process in the rewrite process.

When the host computer 6 issues a direction for data writing into e.g. the logical address LA3(S1 “START”), the card controller 5 receives the writing data Dw(LA3) in response to the issue (S2 “INP−Dw”), and stores the writing data Dw(LA3) in the buffer memory 4 (S3 “STOR−Dw”). The card controller 5 searches a free block table for a free physical address (S4 “REF−FREE(PA8) and then the controller 5 acquires e.g. the physical address PA8. Subsequently, the card controller 5 searches the address translation table for a physical address corresponding to the logical address LA3 targeted for writing. Then, the controller 5 acquires the number of rewrites retained in the acquired physical address, e.g. PA2, namely the data N(20) meaning e.g. twenty times (S5 “OBT−N(20)”). The card controller 5 increments the data by +1 (S6 “INC+1”), and rewrites the data region ARDAT of the physical address PA8 with the data N(21) after the increment and the data Dw(LA3) (S7 “Dw(LA3)->PA8”). After that, the controller 5 updates the address translation table so that the physical address corresponding to the logical address LA3 is made PA8 (S8 “UPD−TAC”), further updates the free block table so as to replace the physical address information of PA8 with the physical address information of PA2 (S9 “UPD−TVA), and terminates the writing process (S10 “END”).

As is clear from FIG. 4, because the number of writings is managed for each logical address, even when the assignment of physical address to a logical address is changed, the number of rewrites held in the data region ARDAT after the change is made a number resulting from the increment by +1. In short, data of a logical address accompanies the history of the number of rewrites on the logical address at all times.

Replacement Process

The card controller 5 is capable of performing a replacement process of memory information on the flash memory 2. The replacement process is a process of replacing a given logical address judged to have a small number of rewrites based on the number-of-rewrites information N (m) so as to correspond to another physical address, performing data transfer according to the replacement.

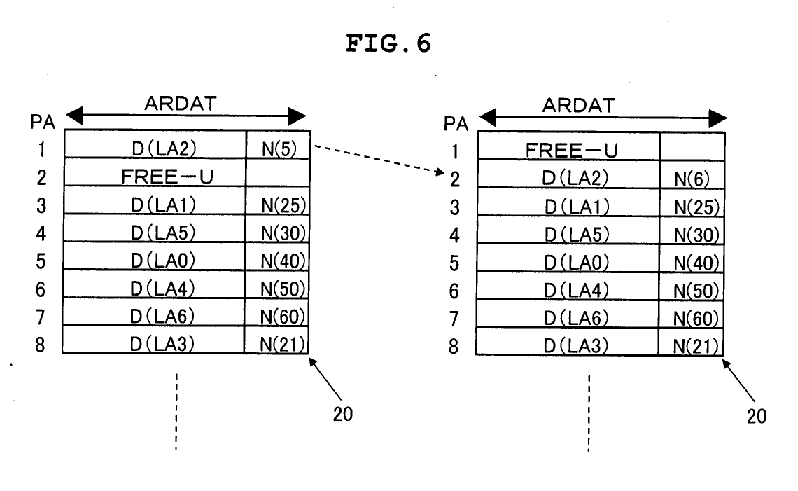

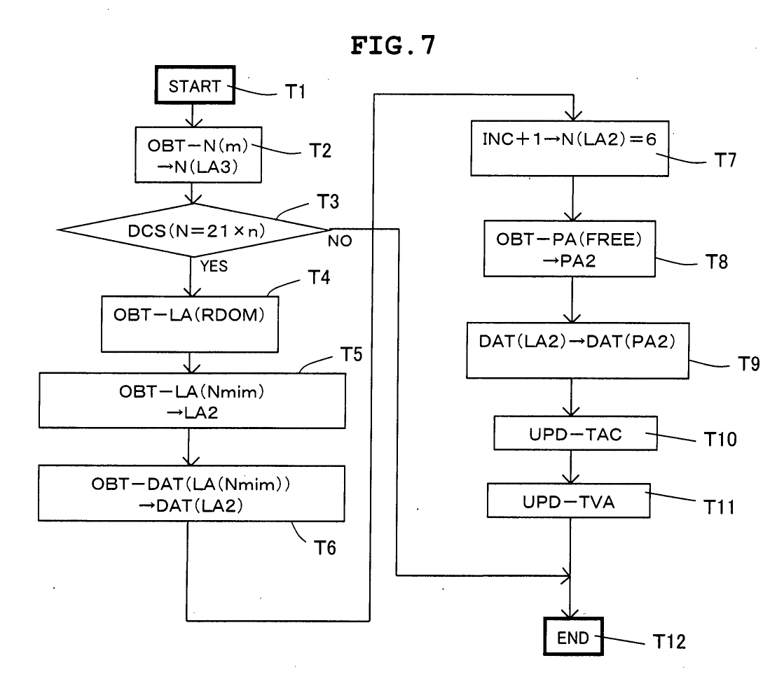

FIG. 6 exemplarily shows how to update data in the user region during the replacement process. FIG. 7 exemplarily shows the flow of the replacement process. The replacement process is arranged so that it can be carried out in parallel with the process in response to a direction for writing provided from the outside of the flash memory card 1 (T1 “START”). Particularly, the replacement process can be executed when the number of rewrites of a logical address targeted for the process in response to the direction for writing reaches a given number of times (e.g. a multiple number of 21). Referring to FIG. 7, when a address targeted for the writing process according to a direction is LA3, number-of-rewrites information N(m) in LA3 is acquired from a physical address corresponding to the logical address (T2 “OBT−N(m)”), and then it is judged whether or not the number of rewrites is a given number of times, e.g. a multiple of 21 (T3 DSC(N=21×n)). When the condition of Step T3 is fulfilled, the replacement process is continued. The given number of times such as a multiple of 21 may be determined appropriately in consideration of a substantial increase in time required for the writing process owing to the replacement process, and the relation of trade-off with accumulation of disturb owing to the unexecution of the replacement process.

When the replacement process is continued, the replacement process is performed on a logical address that is the smallest one in the number of rewrites, of arbitrarily extracted local addresses. Referring to FIG. 7, the card controller 5 generates random numbers, produces logical addresses randomly (T4 “OBT−LA (RDOM)”), accesses the data of the produced logical addresses in the flash memory 2, and acquires a logical address that is the smallest in the number of rewrites (T5 “OBT LA (Nmim)”). For example, in an example of FIG. 6, the logical addresses randomly produced at Step T4 are LA2, LA1, LA5, LA0, LA4, LA6, and so on. Of those logical addresses, a logical address that is the smallest in the number of rewrites is LA2. The number of rewrites of the logical address LA3 targeted for the rewrite process is 21 times.

Then, the data of a physical address corresponding to the logical address (e.g. LA2) acquired at Step T5, which is the smallest in the number of rewrites, is transferred to the buffer (T6 “OBT−DAT(LA(Nmin))”). Subsequently, the number of rewrites of the logical address in question is incremented by +1 (T7 “INC+1”). Referring to FIG. 6, the number of rewrites of LA2 is incremented from 5 times to 6 times. Further, the card controller 5 searches the free block table and then acquires a free physical address (T8 “OBT−PA(FREE)”). Referring to FIG. 6, the physical address PA2 is acquired. The card controller 5 writes data targeted for the replacement process held in the buffer in the acquired physical address (T9 “DAT(LA2)->DAT(PA2)”). After that, the card controller 5 updates the address translation table so that a physical address corresponding to the logical address LA2 is made PA2 (T10 “UPD−TAC”), further updates the free block table so that the physical address information of PA2 is replaced with the physical address information of PA1 (T11 “UPD−TVA”), and then terminates the replacement process (T12 “END”).

As is clear from the foregoing, because the number of rewrites is managed for each logical address, it is untroublesome to grasp a logical address less prone to being rewritten. Also, as is clear from the result of the replacement process as exemplarily shown in FIG. 6, even when data of a logical address (LA2) smaller in the number of rewrites is assigned to another physical address (PA2), the number of rewrites held in the physical address PA2 is still grasped as the number of rewrites N(6) of the logical address LA2 and as such, a condition such that the data of the logical address is prone to being targeted for the rewrite are maintained also in the data region ARDAT, which is a destination of the transfer according to the replacement process. The disturb caused by the rewrite is a phenomenon that is accumulated on data, on which rewrite is not performed. Therefore, a condition where rewrite according to the replacement process on data of a logical address, for which rewrite according to a direction for writing from a host computer does not take place so much, is easy to execute is maintained, whereby it becomes possible to make such data less prone to suffering the accumulation a disturb owing to the rewrite. If the number of rewrites for each physical address is made a guidepost of the replacement process on the assumption of the case where the number of rewrites of the logical address LA2 is as small as 5 times as in FIG. 6 and the number of rewrites of the physical address PA2 is very large, e.g. as large as 300 times, when the logical address LA2 small in the number of rewrites is assigned to the physical address PA2 large in the number of rewrites, rewrite is made difficult to take place with using physical address PA2 in question, and further it is required to wait until other physical addresses are subjected to many times of rewrites, whereby the number of rewrites of the physical address PA2, 300 times, is judged to be relatively smaller. Thus, the physical address PA2 in question would be placed under the influence of disturb for a long time. Therefore, as described above, when the number of rewrites is grasped for each logical address, and the number of rewrites of each logical address is used as a guidepost to perform the replacement process, it becomes possible to prevent accumulation of the influence of disturb from producing undesired transformed data.

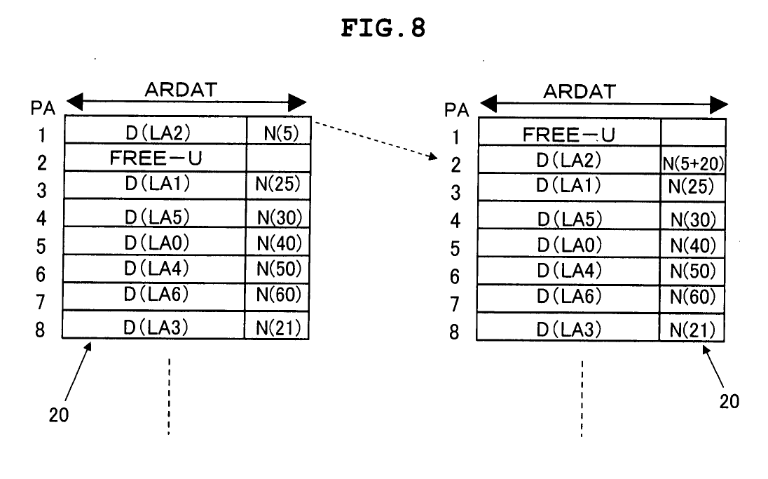

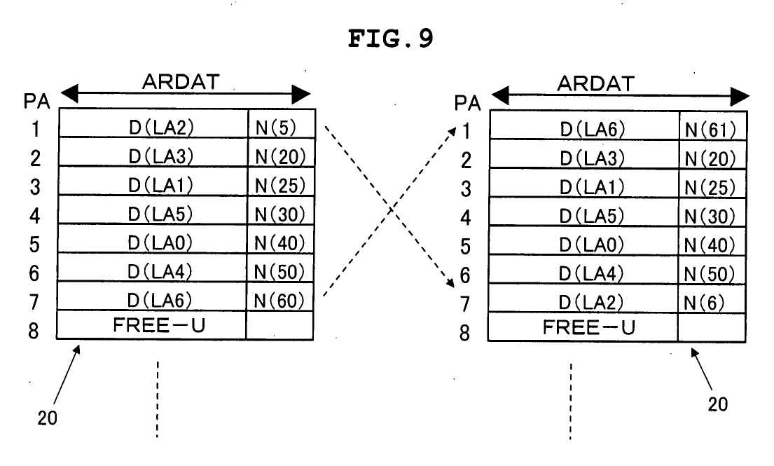

Another example of the replacement process is shown in FIG. 8. While the increment at Step T7 is +1 in the example of FIG. 7, the increment in FIG. 8 is +20. In the example of FIG. 7, the replacement process is performed when the number of rewrites of each logical address reaches a multiple of 21 (T3). Therefore, in consideration of this, the arrangement is made so that the replacement process is not successively executed on the same logical address that is extremely small in the number of rewrites, i.e. so that logical addresses targeted for the replacement process are made easy to disperse within a wide range. In short, when the number of rewrites of the logical address targeted for the replacement process is n times, it is considered the most effective that the number of increments is a value in the vicinity of the n.

Another example of the replacement process is shown in FIG. 9. In the above description, a physical address that is the destination of the replacement is a free physical address that is not used for correspondence to a logical address. However, a physical address that is the destination of the replacement may be a physical address corresponding to another logical address larger in the number of rewrites than a logical address whose number of rewrites is small. In short, data of a logical address larger in the number of rewrites is replaced with data of a logical address smaller in the number of rewrites. For example, a physical address that is the destination of the replacement may be a physical address corresponding to a logical address having the largest number of rewrites, of the numbers of rewrites of logical address acquired at Step T4 in FIG. 7. In the example of FIG. 9, the destination of the replacement is the physical address PA7. In this case, the logical address LA6 that was assigned to the destination of the replacement, i.e. the physical address PA7 is changed in the destination of its assignment to the physical address PA1 that corresponded to the logical address LA2 from which a target for the replacement is taken out, and then required data transfer is performed.

As described above, by replacement of data of a logical address having a large number of rewrites with data of a logical address having a small number of rewrites, the physical address having a large number of rewrites, i.e. the physical address subjected to a large electrical stress owing to rewrites, is made less prone to being placed under a stress caused by rewrite in turn.

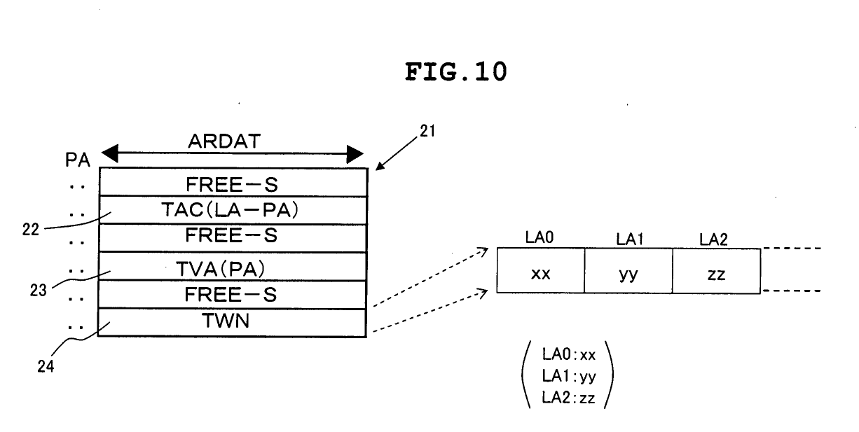

An example of a number-of-rewrites table is shown in FIG. 10. In the above description, the number-of-rewrites information for each logical address is retained in a region of a physical address corresponding to the logical address. However, as shown in FIG. 10, a number-of-rewrites table (TWN) 24 to retain the number-of-rewrites information for each logical address therein may be adopted instead. The number-of-rewrites table 24 may be disposed in the system region 21. The number-of-rewrites table 24 is a unit definition region that is intended to define the number of rewrites for each storage unit e.g. one byte from the beginning in order from the address LA0. For example, number-of-rewrites data of xx times is stored in the unit definition region for the logical address LA0, number-of-rewrites data of yy times is stored in the unit definition region for the subsequent logical address LA1, and number-of-rewrites data of zz times is stored in the unit definition region for the further subsequent logical address LA2.

Flash Memory

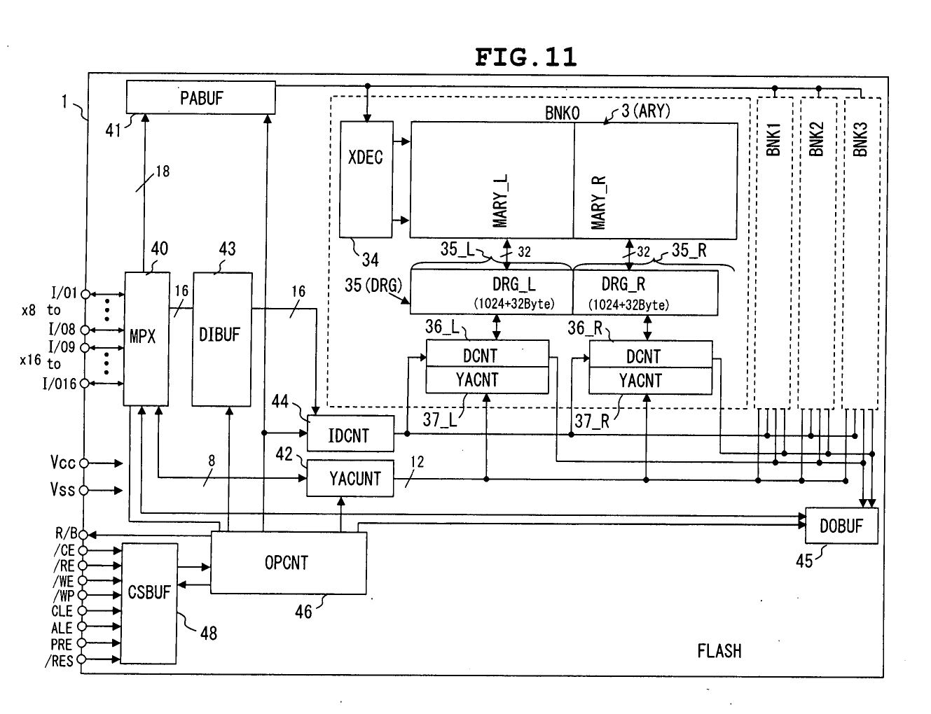

An example of a flash memory is exemplarily shown in FIG. 11. The flash memory 2 is formed on a semiconductor substrate made of e.g. monocrystalline silicon.

The flash memory 2 is not limited particularly, but it has four memory banks BNK0-BNK3. The memory banks BNK0-BNK3 are identical to each other in configuration and arranged so that they can operate in parallel. In the drawing, the configuration of the memory bank BNK0 is exemplarily shown as a representative in detail. The memory banks BNK0-BNK3 each have: a flash memory array (ARY) 3; an X decoder (XDEC) 34; data registers (DRG) 35; data control circuits (DCNT) 36_R, 36_L; and Y address control circuits (YACNT) 37_R, 37_L.

The memory array 3 has a large number of electrically erasable and writable nonvolatile memory transistors. Although the detail of the memory array is to be described later, it is noted here that the memory transistors are not limited particularly, but they are of a stacked-gate structure in which a memory gate is stacked through an insulating film on an electric charge-accumulating region. An erase process that represents initialization of memory information on each memory transistor is not limited particularly. However, the erase process is a process to lower a threshold voltage by applying a ground potential of the circuit to a source, a drain and a well of the memory transistor and applying a negative high voltage to a memory gate thereof, thereby forcing electrons in the electric charge-accumulating region to move toward a direction for emission. A process to write memory information on the memory transistor is a process to increase the threshold voltage by flowing an electric current through the source from the drain of the memory transistor, generating hot electrons in an end portion of the source in a surface of the substrate, and injecting the hot electrons into the electric charge-accumulating region using an electric field created by the high voltage at the memory gate. A readout process is a process to make memory information detectable. According to the readout process, a given readout-judgment level is used as a word line selection level to select the memory transistor in a condition the bit lines are precharged in advance, and the memory information can be detected by a change in electric current flowing through the bit line or a change in voltage level arising in the bit line. A read/write circuit is connected to the bit lines, which is to be described later. The read/write circuit latches the memory information read out into the bit line through the readout process. Also, the read/write circuit is used for activating the bit line, etc. according to data to be written during a write process. Data input/output nodes of the read/write circuit are connected to input/output nodes of a main amplifier through a selector in the bits. Incidentally, the information storage by one nonvolatile memory cell may be binary for 1-bit storage or multivalued for not less than two-bit storage. For example, in the case of two bits, a data register connected to the bit line is further provided to change the readout-judgment level, and 2-bit stored data is judged while separately holding sequential results read out from the memory cell over several times in a sense latch and the data register, whereby the readout process is performed. Further, the write process is performed so that a threshold voltage corresponding to a two-bit value is set while separately holding two-bit write data in the sense latch and the data register. However, this is not a particular limitation.

The flash memory array 3 is not limited particularly. However, the flash memory array 3 is divided into right and left halves (MARY_R, MARY_L). For example, each of MARY_R and MARY_L has a memory capacity of 1024+32 bytes multiplied by 65536 pages. The odd number pages are allotted the left half MARY_L, and even number pages are allotted the right half MARY_R, provided that 1024+32 bytes are treated as a data-storing unit (one page), here. The X decoder decodes a page address used as an access address of the flash memory array. The X decoder is not limited, but it selects the memory cells by the page in a input/output mode of ×8 bits. However, this is not a limitation. The X decoder selects the memory cells in the two pages for each even number page address in a input/output mode of ×16 bits.

The data register 35 has a static memory array. The data register 35 is not limited particularly. However, it is divided into left and right areas (DRG_L, DRG_R). For example, each of the areas DRG_R and DRG_L has a memory capacity of 1024+32 bytes. The areas DRG_R and DRG_L each have a memory capacity representing one page as the data-storing unit. As a matter of convenience, the data register allotted to the area DRG_R is referred to as data register 35_R and the data register allotted to the area DRG_L is referred to as data register 35_L.

The flash memory array 3 and the data register 35 serve to input/output data. For example, when the selector provided in the flash memory array 3 connects the data input/output nodes of the read/write circuit to the input/output nodes of the main amplifier in the 32 bits, the selection by the selector is switched by an internal clock automatically in sequence, whereby data transmission representing one page is made possible between the memory array 3 and the data registers 35_L and 35_R.

The data registers 35_L, 35_R are constituted by e.g. SRAMs. Here, the area DRG_R and the area DRG_L are constituted by different SRAMs respectively. The data control circuit 36_R(36_L) controls data input/output to the data register 35_R (35_L). The Y address control circuit 37R (37L) performs address control on the data register 35_R(35L).

External input/output terminals I/O1-I/O16 serve as an address input terminal, a data input terminal, a data output terminal and a command input terminal, too. The external input/output terminals are connected to a multiplexer (MPX) 40. A page address input to the external input/output terminals I/O1-I/O16 is input through the multiplexer 40 to the page address buffer (PABUF) 41, and a Y address (column address) is passed through the multiplexer 40 and then preset in a Y address counter (YACUNT) 42. Write data input to the external input/output terminals I/O1-I/O16 is passed through the multiplexer 40 and then supplied to a data input buffer (DIBUF) 43. The write data supplied to the data input buffer 43 is passed through an input data control circuit (IDCNT) 44 and input to the data control circuits 36_L, 36_R. For data input/output through the external input/output terminals I/O1-I/O16, ×8-bit or ×16-bit input/output is selected. When ×16-bit input/output is selected, the input data control circuit 44 provides 16-bit write data in parallel so as to suit the data control circuits 36_R, 36_L. When ×8-bit input/output is selected, the input data control circuit 44 provides 8-bit write data to the data control circuit 36_L in the case of an odd number page, and provides 8-bit write data to the data control circuit 36_R in the case of an even number page. The read data output from the data control circuits 36_R, 36_L are supplied through a data output buffer (DOBUF) 45 to the multiplexer 40 and then output from the external input/output terminals I/O1-I/O16.

Parts of a command code and an address signal, which are supplied to the external input/output terminals I/O1-I/O16, are passed through the multiplexer 40 and then supplied to an internal control circuit (OPCNT) 46.

A page address supplied to the page address buffer 41 is decoded by the X decoder 34. According to the result of the decoding, a word line is selected from the memory array 3. The Y address counter 42 on which a Y address supplied to the page address buffer 41 is preset is not limited particularly. However, the Y address counter 42 is a 12-bit counter, which performs address count using the preset value as a starting point and supplies the counted Y address to the Y address control circuits 37_R, 37_L. The counted Y address is utilized for an address signal when the write data from the input data control circuit (IDCNT) 44 is written in the data register 35 or when read data to be supplied to the output buffer 45 is selected from the data register 35. The Y address supplied to the page address buffer 41 is equal to the leading address of the counted Y address. The leading Y address is referred to as access leading Y address.

The control signal buffer (CSBUF) 48 is supplied with, as access control signals from the outside, a chip enable signal /CE, a command latch enable signal CLE, an address latch enable signal ALE, a write enable signal /WE, a read enable signal /RE, a write protect signal /WP, a power-on read enable signal PRE, and a reset signal /RES. The symbol “/” attached to the tops of the signals means that the signals is low-enable.

The chip enable signal /CE is a signal to select the operation of the flash memory 2. When the chip enable signal /CE is at low level, the flash memory (device) 2 is made active (operable). When the chip enable signal /CE is at high level, the flash memory 2 is made standby (operation-stopped). The read enable signal /RE is for controlling data output timing from the external input/output terminals I/O1-I/O16. In synchronization with a change in clock of the signal, data is read out. As for the write enable signal /WE, its rising edge is used to direct capture of a command, an address, and data into the flash memory 2. The command latch enable signal CLE is a signal to instruct that data supplied from the outside to the external input/output terminals I/O1-I/O16 should be recognized as a command. The data captured in synchronization with the rising edge of the write enable signal /WE when CLE “H” holds concerning the data at the input/output terminals I/O1-I/O16 is recognized as a command. The address latch enable signal ALE is a signal to direct that data supplied from the outside to the external input/output terminals I/O1-I/O16 is an address. The data captured in synchronization with the rising edge of the write enable signal /WE when ALE=“H” (High level) holds concerning the data at the input/output terminals I/O1-I/O16 is recognized as an address. As for the write protect signal /WP, when it is at its low level, erase and write on the flash memory 2 are forbidden. The power-on read enable signal PRE is made enable when a power-on-read function to read out data in a given sector without entering a command and an address after the turning-on of the power source is used. The reset signal /RES directs an operation for initialization to the flash memory 2 when it is caused to transition from its low level to the high level after the turning-on of the power source.

The internal control circuit 46 performs interface control according to an access control signal or the like, and controls internal operations for the erase process, the write process, the readout process, etc. according to input commands. Also, the internal control circuit 46 outputs a ready-busy signal R/B. The ready-busy signal R/B is made its low level while the flash memory 2 is in operation, whereby the busy state thereof is notified to the outside. Vcc is a source voltage. Vss is the ground voltage. The high voltage required for the write and erase processes is produced based on the source voltage Vcc by an internal step-up circuit (not shown).

In still another representative concrete form of the invention, the nonvolatile memory has an address translation table in which the correspondence between a logical address and a physical address is defined.

When a memory card 1 as shown in FIG. 1 is constructed, not only the flash memory 2 may be arranged so that the replacement process, etc. are performed based on the number of rewrites for each logical address under the control of the card controller 5 connected to the outside, but also the internal control circuit 46 in the flash memory 2 may be arranged so that the internal control circuit 46 performs the replacement process, etc. based on the number of rewrites for each logical address likewise. Even in the case where the card controller 5 connected to the outside does not have the function of performing the replacement process in association with the invention, the flash memory 2 is arranged so as to perform the replacement process in association with the invention by itself, whereby it can be made less prone to suffering disturb owing to rewrite of the other address even with data stored in a logical address for which rewrite rarely takes place.

For example, even with a flash memory-combined microcomputer including a flash memory, a CPU, etc. constructed on a single semiconductor substrate, the CPU may perform the replacement process in association with the invention.

The invention made by the inventor has been specifically described based on the embodiments above. However, the invention is not so limited. It is needless to say that various modifications and changes may be made within a scope not departing from the subject matters thereof.

For example, the selection of a logical address targeted for the replacement process is not limited to the way to select from logical addresses in a random order, and an appropriate selection algorithm may be adopted. Also, the number of rewrites required to proceed to the replacement process is not limited to a multiple of 21, and it may be changed appropriately. Further, the replacement process is not limited so that it is performed together with the process in response to a direction for writing from a host, and it may be performed subordinately to a process in response to another direction from the host.

The invention can be applied widely to various kinds of memory apparatuses including a flash memory card and memory cards with a nonvolatile memory attached thereto other than the flash memory card, and a multifunction card having e.g. a microcomputer for an IC card together with an on volatile memory, a flash memory, a flash memory-combined microcomputer and the like.

What is claimed is:

1. A memory apparatus comprising:
a rewritable nonvolatile memory; and
a control circuit,
wherein the memory apparatus brings logical addresses into correspondence with physical addresses of the nonvolatile memory and retains a piece of number-of-rewrites information for each logical address,
wherein the control circuit can perform a replacement process of a piece of memory information on the nonvolatile memory, and
wherein the replacement process is a process of replacing a first physical address corresponding to a given logical address judged to have a small number of rewrites based on the pieces of number-of-rewrites information with a second physical address so as to bring the given logical address into another correspondence with the second physical address and performing data transfer according to the replacement.

2. The memory apparatus of claim 1, wherein the second physical address is a free physical address used for a correspondence with no logical address.

3. The memory apparatus of claim 1, wherein the second physical address is a physical address corresponding to a second logical address of the logical addresses, having a larger number of rewrites in comparison to the given logical address having the small number of rewrites, and
wherein the second logical address is changed so as to be brought into correspondence with the first physical address to which the given logical address having the small number of rewrites was assigned.

4. The memory apparatus of claim 1, wherein the replacement process can be performed concurrently with a process in response to a direction for writing provided from an outside of a memory card.

5. The memory apparatus of claim 4, wherein the replacement process can be performed when the number of rewrites of the logical address targeted for the process in response to the direction for writing reaches a given number of times.

6. The memory apparatus of claim 5, wherein the replacement process can be performed on a logical address having a smallest number of rewrites, of arbitrarily extracted logical addresses.

7. The memory apparatus of claim 4, wherein during the process in response to the direction for writing, the control circuit brings the logical address targeted for the process into correspondence with a third physical address and performs data rewrite.

8. The memory apparatus of claim 7, wherein the nonvolatile memory has an address translation table in which correspondences of the logical addresses and physical addresses are defined.

9. The memory apparatus of claim 8, wherein the number-of-rewrites information for each logical address is retained in a region of the physical address corresponding to the logical address.

10. The memory apparatus of claim 8, wherein the number-of-rewrites information for each logical address is retained in a number-of-rewrites table.

11. A memory card comprising:
a rewritable nonvolatile memory; and
a control circuit,
wherein the memory card brings logical addresses into correspondence with physical addresses of the nonvolatile memory, and retains a piece of number-of-rewrites information for each logical address,
wherein the control circuit can executes a rewrite process of the nonvolatile memory in response to a direction for writing from an outside, and a replacement process of memory information on the nonvolatile memory, and
wherein the replacement process is a process of replacing a first physical address corresponding to a given logical address judged to have a small number of rewrites based on the pieces of number-of-rewrites information with a second physical address so as to bring the given logical address into another correspondence with the second physical address and performing data transfer according to the replacement.

12. A controller, performing host interface control and memory control on a rewritable nonvolatile memory,
wherein the memory control includes control of bringing logical addresses into correspondence with physical addresses of the nonvolatile memory to manage a piece of number-of-rewrites information for each logical address, and control of a replacement process that can be executed in performing rewrite on the nonvolatile memory, and
wherein the replacement process is a process of replacing a first physical address corresponding to a given logical address judged to have a small number of rewrites based on the pieces of number-of-rewrites information with a second physical address so as to bring the given logical address into another correspondence with the second physical address and performing data transfer according to the replacement.

13. The controller of claim 12, wherein the second physical address is a free physical address used for correspondence with no logical address.

14. The controller of claim 13, wherein the second physical address is a physical address corresponding to a second logical address of the logical addresses, having a larger number of rewrites in comparison to the given logical address having the small number of rewrites, and
wherein the second logical address is changed so as to be brought into correspondence with the first physical address to which the given logical address having the small number of rewrites was assigned.

15. The controller of claim 12, wherein the replacement process can be performed concurrently with a process in response to a direction for writing on a volatile memory provided from an outside thereof.

16. The controller of claim 15, wherein the replacement process can be performed when the number of rewrites of the logical address targeted for the process in response to the direction for writing reaches a given number of times.

17. The controller of claim 16, wherein the replacement process can be performed on a logical address having a smallest number of rewrites, of arbitrarily extracted logical addresses.
